(19) United States
(12) Patent Application Publication
(10) Pub. No.: US 2015/0293608 A1
(43) Pub. Date: Oct. 15, 2015

(54) ELECTRONIC DEVICE AND TEXT INPUT METHOD THEREOF

(71) Applicant: Samsung Electronics Co., Ltd., Suwon-si (KR)

(72) Inventors: Byeongnam Kim, Seongnam-si (KR); Changkyu Kim, Seoul (KR); Sangmin Choi, Suwon-si (KR); Kwangjae Hwang, Suwon-si (KR)

(21) Appl. No.: 14/684,250

(22) Filed: Apr. 10, 2015

(30) Foreign Application Priority Data
Apr. 11, 2014 (KR) 10-2014-0043346

(51) Int. Cl. G06F 3/023; G06F 3/00; H04W 4/00; G06F 3/01

(52) U.S. Cl. CPC G06F 3/0237; G06F 3/011; G06F 3/005; G06F 3/015; H04W 4/008

(57) ABSTRACT

An electronic device includes a sensor unit having a touch sensor for detecting a key input based on a touch, and a keypad including a first key group and a second key group. The first key group has a first plurality of keys and a first shift key, and the second key group has a second plurality of keys and a second shift key. The first plurality of keys performs a first input or a second input by detecting the key input from the sensor unit, and the first shift key performs the second input by detecting the key input from the sensor unit. Similarly, the second plurality of keys performs a third input or a fourth input by detecting the key input from the sensor unit, and the second shift key performs the fourth input by detecting the key input from the sensor unit.

### TECHNICAL FIELD

The present disclosure relates generally to text input technology for electronic devices.

### BACKGROUND

Nowadays electronic devices have been often developed in the form of wearable devices which are differentiated from existing smart phones. In order to realize a lighter product with a simpler design, such wearable devices have no touch panel which has been widely used as an input mechanism. Instead, typical wearable devices employ a text input mechanism using voice recognition or the like. However, this input technique based on voice recognition is sensitive to ambient noise and thus has poor input accuracy.

### SUMMARY

In order to obviate the above-discussed drawbacks, a variety of embodiments of the present disclosure provide a reliable and accurate text input mechanism using a part of a human body. Specifically, embodiments of this disclosure provide an electronic device and method for allowing a text input based on a simple array of letters corresponding to a part of a human body and a gesture thereof. Further, this electronic device may be applied as an input device to a wearable device and also coupled to any other electronic device for displaying a text input through a short range communication such as Bluetooth.

According to various embodiments of this disclosure, a text input method of an electronic device includes recognizing a selected key, activating the recognized key, creating a letter corresponding to the activated key, and transmitting the created letter to an external electronic device for displaying the created letter.

According to various embodiments of this disclosure, an electronic device comprises a sensor unit including a touch sensor configured to detect a key input based on a touch, and a keypad including a first key group and a second key group. The first key group has a first plurality of keys and a first shift key, and the second key group has a second plurality of keys and a second shift key. The first plurality of keys performs a first input or a second input by detecting the key input from the sensor unit, and the first shift key performs the second input by detecting the key input from the sensor unit. The second plurality of keys performs a third input or a fourth input by detecting the key input from the sensor unit, and the second shift key performs the fourth input by detecting the key input from the sensor unit. The electronic device further comprises a wireless communication unit configured to communicate with an external electronic device, and a processor configured to recognize a specific key selected from the keypad, to activate the recognized key, to create a letter corresponding to the activated key, and to transmit the created letter to the external electronic device for displaying the created letter through the wireless communication unit.

According to various embodiments of this disclosure, an electronic device comprises an input unit including a camera configured to capture an image, a wireless communication unit configured to communicate with an external electronic device, and a processor configured to receive the captured image from the camera, to create a letter by recognizing the letter from the received image, and to transmit the created letter to the external electronic device for displaying the created letter through the wireless communication unit.

To address the above-discussed deficiencies, it is a primary object to provide an electronic device comprises a sensor unit including an electromyogram sensor configured to detect a movement of user's muscles, a wireless communication unit configured to communicate with an external electronic device, and a processor configured to receive the detected muscle movement from the electromyogram sensor, to create a letter corresponding to the received muscle movement, and to transmit the created letter to the external electronic device for displaying the created letter through the wireless communication unit.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a block diagram illustrating a network environment including therein an electronic device in accordance with various embodiments of this disclosure.

FIG. 2 is a block diagram illustrating an electronic device in accordance with various embodiments of the present disclosure.

FIG. 3 is a block diagram illustrating an electronic device in accordance with various embodiments of the present disclosure.

FIG. 4 is a block diagram illustrating an external electronic device in accordance with various embodiments of the present disclosure.

FIG. 5 is a flow diagram illustrating a text input and display process based on a communication between electronic devices in accordance with various embodiments of the present disclosure.

FIGS. 6A and 6B show examples of key arrangement for a text input in accordance with embodiments of the present disclosure.

FIG. 7 shows an operation example of an electronic device in accordance with embodiments of the present disclosure.

FIG. 8 shows another operation example of an electronic device in accordance with embodiments of the present disclosure.

FIG. 9 shows a text input example of an electronic device in accordance with embodiments of the present disclosure.

FIG. 10 shows a text display example of an external electronic device in accordance with embodiments of the present disclosure.

FIG. 11 shows a text input example in accordance with embodiments of the present disclosure.

FIGS. 12A and 12B show examples of key arrangement for a text input in accordance with embodiments of the present disclosure.

### DETAILED DESCRIPTION

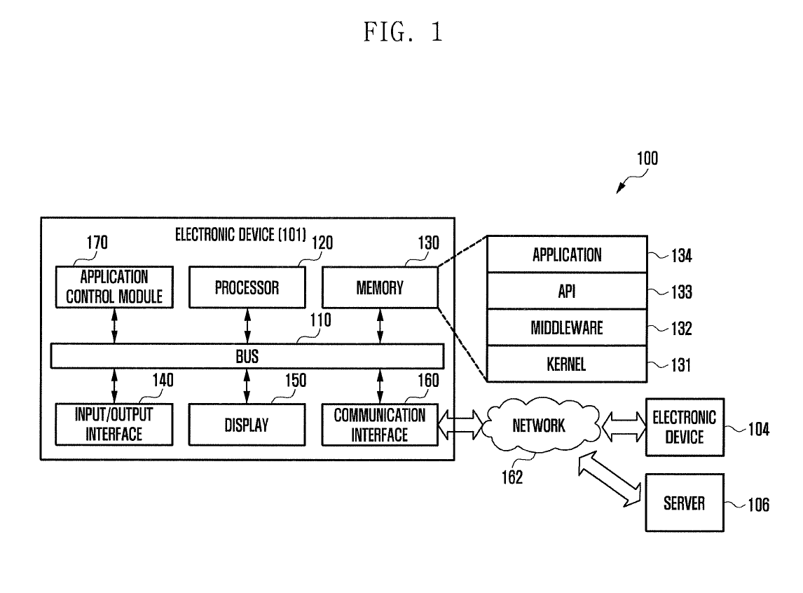

FIGS. 1 through 12B, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged electronic devices.

Hereinafter, embodiments of the present disclosure will be described in detail with reference to the accompanying drawings. It will be easily appreciated to those skilled in the art that various modifications, additions and substitutions are possible from the embodiment of the present disclosure, and the scope of the disclosure should not be limited to the following embodiments. The embodiments of the present disclosure are provided such that those skilled in the art completely understand the disclosure. In the drawings, the same or similar elements are denoted by the same reference numerals even though they are depicted in different drawings.

The expressions such as “include” and “may include” which may be used in the present disclosure denote the presence of the disclosed functions, operations, and constituent elements and do not limit one or more additional functions, operations, and constituent elements. In the present disclosure, the terms such as “include” and/or “have” may be construed to denote a certain characteristic, number, step, operation, constituent element, component or a combination thereof, but may not be construed to exclude the existence of or a possibility of the addition of one or more other characteristics, numbers, steps, operations, constituent elements, components or combinations thereof.

In the present disclosure, the expression “and/or” includes any and all combinations of the associated listed words. For example, the expression “A and/or B” may include A, may include B, or may include both A and B.

In the present disclosure, expressions including ordinal numbers, such as “first” and “second,” etc., and/or the like, may modify various elements. However, such elements are not limited by the above expressions. For example, the above expressions do not limit the sequence and/or importance of the elements. The above expressions are used merely for the purpose of distinguishing an element from the other elements. For example, a first user device and a second user device indicate different user devices although for both of them the first user device and the second user device are user devices. For example, a first element could be termed a second element, and similarly, a second element could be also termed a first element without departing from the scope of the present disclosure.

In the case where according to which a component is referred to as being “connected” or “accessed” to other component, it should be understood that not only the component is directly connected or accessed to the other component, but also another component may exist between the component and the other component. Meanwhile, in the case where according to which a component is referred to as being “directly connected” or “directly accessed” to other component, it should be understood that there is no component therebetween.

The terms used in the present disclosure are only used to describe specific various embodiments, and are not intended to limit the present disclosure. Singular forms are intended to include plural forms unless the context clearly indicates otherwise.

Unless otherwise defined, all terms including technical and/or scientific terms used herein have the same meaning as commonly understood by one of ordinary skill in the art to which the disclosure pertains. In addition, unless otherwise defined, all terms defined in generally used dictionaries may not be overly interpreted.

The electronic device according to the embodiments of the present disclosure is a device including a heart rate measuring function. For example, the electronic device corresponds to a combination of at least one of the followings: a smartphone, a tablet Personal Computer (PC), a mobile phone, a video phone, an e-book reader, a desktop PC, a laptop PC, a netbook computer, a Personal Digital Assistant (PDA), a Portable Multimedia Player (PMP), a digital audio player (e.g., MP3 player), a mobile medical device, a camera, or a wearable device. Examples of the wearable device are a head-mounted-device (HMD) (e.g., electronic eyeglasses), electronic clothing, an electronic bracelet, an electronic necklace, an appcessory, an electronic tattoo, a smart watch, etc.

The electronic device according to the embodiments of the present disclosure is smart home appliances with a heart rate measuring function. Examples of the smart home appliances are a television (TV), a Digital Video Disk (DVD) player, an audio system, a refrigerator, an air-conditioner, a cleaning device, an oven, a microwave oven, a washing machine, an air cleaner, a set-top box, a TV box (e.g., Samsung HomeSync™, Apple TV™, or Google TV™), a game console, an electronic dictionary, an electronic key, a camcorder, an electronic album, or the like.

The electronic device according to the embodiments of the present disclosure includes at least one of the following: medical devices (e.g., Magnetic Resonance Angiography (MRA), Magnetic Resonance Imaging (MRI), Computed Tomography (CT), a scanning machine, an ultrasonic scanning device, etc.), a navigation device, a Global Positioning System (GPS) receiver, an Event Data Recorder (EDR), a Flight Data Recorder (FDR), a vehicle infotainment device, an electronic equipment for ships (e.g., navigation equipment, gyrocompass, etc.), avionics, a security device, a head unit for vehicles, an industrial or home robot, an automatic teller's machine (ATM), a point of sales (POS) system, etc.

The electronic device according to the embodiments of the present disclosure includes at least one of the following: furniture or a portion of a building/structure, an electronic board, an electronic signature receiving device, a projector, various measuring instruments (e.g., a water meter, an electric meter, a gas meter and a wave meter), etc., which are equipped with a heart rate measuring function, respectively. The electronic device according to the embodiments of the present disclosure also includes a combination of the devices listed above. In addition, the electronic device according to the embodiments of the present disclosure is a flexible device. It is obvious to those skilled in the art that the electronic device according to the embodiments of the present disclosure is not limited to the aforementioned devices.

Hereinafter, electronic devices according the embodiments of the present disclosure are described in detail with reference to the accompanying drawings. In the description, the term a ‘user’ is referred to as a person or a device that uses an electronic device, e.g., an artificial intelligent electronic device.

FIG. 1 illustrates a network environment 100 including an electronic device 101 according to an embodiment of the present disclosure. Referring to FIG. 1, the electronic device 101 includes a bus 110, a processor 120, a memory 130, an input/output (I/O) interface 140, a display 150, a communication interface 160 and an application control module 170.

The bus 110 is a communication circuit that connects the components to each other and transfers data (e.g., control messages) between the components.

The processor 120 receives instructions from the components (e.g., the memory 130, input/output interface 140, display 150, communication interface 160, application control module 170, etc.) via the bus 110, decode them and perform corresponding operations or data processing according to the decoded instructions.

The memory 130 stores instructions or data transferred from/created in the processor 120 or the other components (e.g., the input/output interface 140, display 150, communication interface 160, application control module 170, etc.). The memory 130 includes programming modules, e.g., a kernel 131, middleware 132, application programming interface (API) 133, application module 134, etc. Each of the programming modules is software, firmware, hardware or a combination thereof.

The kernel 131 controls or manages system resources (e.g., the bus 110, processor 120, memory 130, etc.) used to execute operations or functions of the programming modules, e.g., the middleware 132, API 133, and application module 134. The kernel 131 also provides an interface that can access and control/manage the components of the electronic device 101 via the middleware 132, API 133, and application module 134.

The middleware 132 makes it possible for the API 133 or application module 134 to perform data communication with the kernel 131. The middleware 132 also performs control operations (e.g., scheduling, load balancing) for task requests transmitted from the application module 134 by methods, for example, a method for assigning the order of priority to use the system resources (e.g., the bus 110, processor 120, memory 130, etc.) of the electronic device 101 to at least one of the applications of the application module 134.

The application programming interface (API) 133 is an interface that allows the application module 134 to control functions of the kernel 131 or middleware 132. For example, the API 133 includes at least one interface or function (e.g., instruction) for file control, window control, character control, video process, etc.

In embodiments of the present disclosure, the application module 134 includes applications that are related to: SMS/MMS, email, calendar, alarm, health care (e.g., an application for measuring the blood sugar level, a workout application, etc.), environment information (e.g., atmospheric pressure, humidity, temperature, etc.), and so on. The application module 134 is an application related to exchanging information between the electronic device 101 and the external electronic devices (e.g., an electronic device 104). The information exchange-related application includes a notification relay application for transmitting specific information to an external electronic device or a device management application for managing external electronic devices.

For example, the notification relay application includes a function for transmitting notification information, created by the other applications of the electronic device 101 (e.g., SMS/MMS application, email application, health care application, environment information application, etc.), to an external electronic device (e.g., electronic device 104). In addition, the notification relay application receives notification information from an external electronic device (e.g., electronic device 104) and provides it to the user. The device management application can manage (e.g., to install, delete, or update): part of the functions of an external electronic device (e.g., electronic device 104) communicating with the electronic device 101, e.g., turning on/off the external electronic device, turning on/off part of the components of the external electronic device, adjusting the brightness (or the display resolution) of the display of the external electronic device, etc.; applications operated in the external electronic device; or services from the external electronic device, e.g., call service or messaging service, etc.

In embodiments of the present disclosure, the application module 134 includes applications designated according to attributes (e.g., type of electronic device) of the external electronic device (e.g., electronic device 104). For example, if the external electronic device is an MP3 player, the application module 134 includes an application related to music playback. If the external electronic device is a mobile medical device, the application module 134 includes an application related to health care. In an embodiment of the present disclosure, the application module 134 includes at least one of the following: an application designated in the electronic device 101 and applications transmitted from external electronic devices (e.g., server 106, electronic device 104, etc.).

The input/output interface 140 receives instructions or data from the user via an input/output system (e.g., a sensor, keyboard or touch screen) and transfers them to the processor 120, memory 130, communication interface 160 or application control module 170 through the bus 110. For example, the input/output interface 140 provides data corresponding to a user's touch input to a touch screen to the processor 120. The input/output interface 140 receives instructions or data from the processor 120, memory 130, communication interface 160 or application control module 170 through the bus 110, and output them to an input/output system (e.g., a speaker or a display). For example, the input/output interface 140 outputs voice data processed by the processor 120 to the speaker.

The display 150 displays information (e.g., multimedia data, text data, etc.) on the screen so that the user views it.

The communication interface 160 communicates between the electronic device 101 and an external system (e.g., an electronic device 104 or server 106). For example, the communication interface 160 connects to a network 162 in wireless or wired mode and communicate with the external system. Wireless communication includes at least one of the following: Wireless Fidelity (Wi-Fi), Bluetooth (BT), near field communication (NFC), global positioning system (GPS) or cellular communication (e.g., LTE, LTE-A, CDMA, WCDMA, UMTS, Wi-Bro, GSM, etc.). Wired communication includes at least one of the following: universal serial bus (USB), high definition multimedia interface (HDMI), recommended standard 232 (RS-232), plain old telephone service (POTS), etc.

In an embodiment of the present disclosure, the network 162 is a telecommunication network. The telecommunication network includes at least one of the following: a computer network, Internet, Internet of things, telephone network, etc. The protocol for communication between the electronic device 101 and the external system, e.g., transport layer protocol, data link layer protocol, or physical layer protocol, is supported by at least one of the following: application module 134, API 133, middleware 132, kernel 131 and communication module 160.

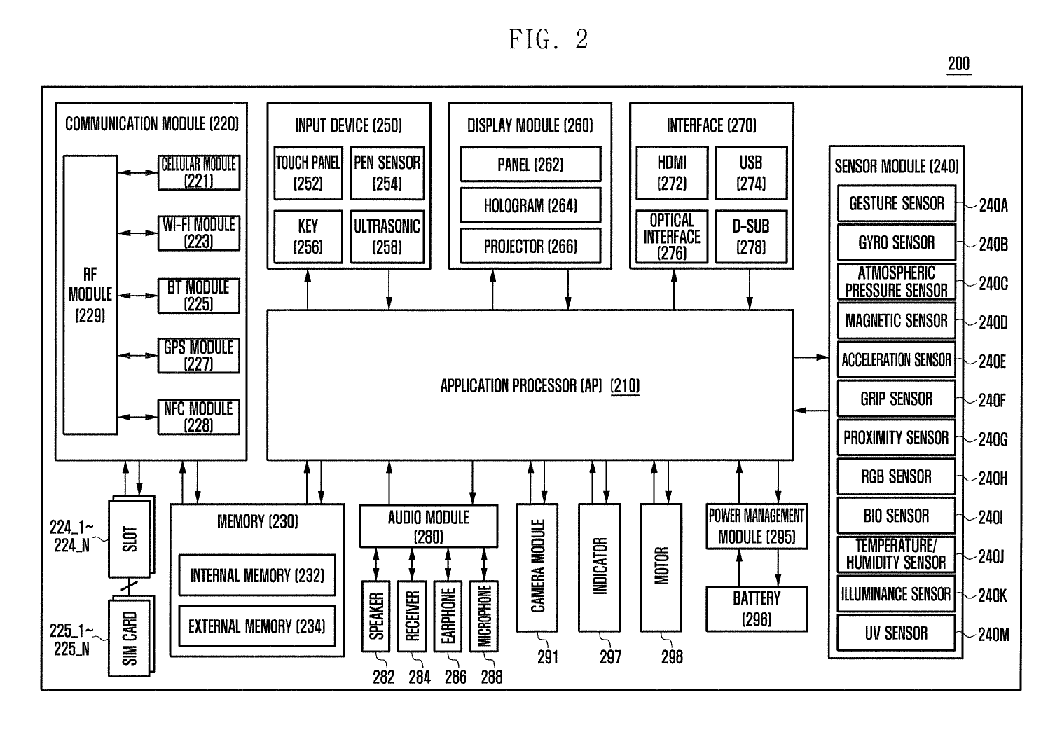

FIG. 2 illustrates a schematic block diagram of an electronic device according to an embodiment of the present disclosure. The electronic device is part or all of electronic device 101 as shown in FIG. 1. Referring to FIG. 2, the electronic device includes one or more processors of the application processor 210, a communication module 220, a subscriber identification module (SIM) card 224, a memory 230, a sensor module 240, an input system 250, a display module 260, an interface 270, an audio module 280, a camera module 291, a power management module 295, a battery 296, an indicator 297, and a motor 298.

The application processor (AP) 210 controls a number of hardware or software components connected thereto by executing the operation system or applications, process data including multimedia data, and perform corresponding operations. The AP 210 is implemented with a system on chip (SoC). In an embodiment of the present disclosure, the AP 210 further includes a graphic processing unit (GPU).

The communication module 220 (e.g., communication interface 160) performs communication for data transmission/reception between the other electronic devices (e.g., an electronic device 104, server 106) that are connected to the electronic device (e.g., electronic device 101) via the network. In an embodiment of the present disclosure, the communication module 220 include a cellular module 221, a Wi-Fi module 223, a Bluetooth (BT) module 225, a GPS module 227, an NFC module 228 and a radio frequency (RF) module 229.

The cellular module 221 provide voice call, video call, SMS or Internet service, etc., via a communication network (e.g., LTE, LTE-A, CDMA, WCDMA, UMTS, Wi-Bro, GSM, etc.). The cellular module 221 performs identification or authentication for electronic devices in a communication network by using their subscriber identification module (e.g., SIM card 224). In an embodiment of the present disclosure, the cellular module 221 performs part of the functions of the AP 210. For example, the cellular module 221 performs part of the functions for controlling multimedia.

In an embodiment of the present disclosure, the cellular module 221 includes a communication processor (CP). The cellular module 221 is implemented with, for example, a SoC. Although the embodiment of the present disclosure shown in FIG. 2 is implemented in such a way that the cellular module 221 (e.g., communication processor), the power management module 295, the memory 230, etc., are separated from the AP 210, it is modified in such a way that the AP 210 includes at least part of those (e.g., cellular module 221).

In an embodiment of the present disclosure, the AP 210 or the cellular module 221 (e.g., communication processor) loads instructions or data transmitted from at least one of the following: non-volatile memory or other components, on a volatile memory and then process them. The AP 210 or the cellular module 221 also stores data in a non-volatile memory, which is transmitted from/created in at least one of the other components.

The Wi-Fi module 223, the BT module 225, the GPS module 227 and the NFC module 228 includes processors for processing transmission/reception of data, respectively. Although the embodiment of the present disclosure shown in FIG. 2 is implemented in such a way that the cellular module 221, Wi-Fi module 223, BT module 225, GPS module 227, and NFC module 228 are separated from each other, it is modified in such a way that part of those (e.g., two or more) are included in an integrated chip (IC) or an IC package. For example, part of the processors corresponding to the cellular module 221, Wi-Fi module 223, BT module 225, GPS module 227, and NFC module 228, e.g., a communication processor corresponding to the cellular module 221 and a Wi-Fi processor corresponding to the Wi-Fi 223, is implemented with a SoC.

The radio frequency (RF) module 229 transmits or receives data, e.g., RF signals. The RF module 229 includes a transceiver, a power amplifier module (PAM), a frequency filter, a low noise amplifier (LNA), etc. The RF module 229 also includes parts for transmitting/receiving electromagnetic waves, e.g., conductors, wires, etc., via free space during wireless communication. Although the embodiment of the present disclosure shown in FIG. 2 is implemented in such a way that the cellular module 221, Wi-Fi module 223, BT module 225, GPS module 227, and NFC module 228 share the RF module 229, it is modified in such a way that at least one of those transmits or receives RF signals via a separate RF module.

The subscriber identification module (SIM) card 224 is a card with a subscriber identification module (SIM). The SIM cards 224 are fitted into a slot of the electronic device. The SIM card 224 includes unique identification information, e.g., integrated circuit card identifier (ICCID), or subscriber information, e.g., international mobile subscriber identity (IMSI).

The memory 230 (e.g., memory 130) includes built-in memory 232 and/or external memory 234. The built-in memory 232 includes at least one of the following: volatile memory, e.g., dynamic RAM (DRAM), static RAM (SRAM), synchronous dynamic RAM (SDRAM), etc.; non-volatile memory, e.g., one time programmable ROM (OTPROM), programmable ROM (PROM), erasable and programmable ROM (EPROM), electrically erasable and programmable ROM (EEPROM), mask ROM, flash ROM, NAND flash memory, NOR flash memory, etc.

In an embodiment of the present disclosure, the built-in memory 232 is a Sold State Drive (SSD). The external memory 234 further includes a flash drive, e.g., compact flash (CF), secure digital (SD), micro-secure digital (micro-SD), mini-secure digital (mini-SD), extreme digital (XD), a memory stick, etc. The external memory 234 is functionally connected to the electronic device via various types of interface. In an embodiment of the present disclosure, the electronic device 101 further includes storage devices (or storage media) such as hard drives.

The sensor module 240 measures physical quantity or sense operation states of the electronic device 101 and convert the measured or sensed data to electrical signals. The sensor module 240 includes at least one of the following: gesture sensor 240A, gyro sensor 240B, atmospheric pressure sensor 240C, magnetic sensor 240D, acceleration sensor 240E, grip sensor 240F, proximity sensor 240G, color sensor 240H (e.g., red-green-blue (RGB) sensor), biosensor 240I, temperature/humidity sensor 240J, luminance sensor 240K, and ultra-violet (UV) sensor 240M.

The input system 250 includes a touch panel 652, a pen sensor 254 (i.e., a digital pen sensor), a key 256 and an ultrasonic input system 258. The touch panel 252 senses touches in at least one of the following: capacitive sensing mode, pressure sensing mode, infrared sensing mode, and ultrasonic sensing mode. The touch panel 252 further includes a control circuit. When the touch panel 252 is designed to operate in capacitive sensing mode, it senses mechanical/physical touches or proximity of an object. The touch panel 252 further includes a tactile layer. In that case, the touch panel 252 provides tactile feedback to the user.

The pen sensor 254 (i.e., digital pen sensor) is implemented in the same or similar way as receiving a user's touch input or by using a separate recognition sheet. The key 256 include mechanical buttons, optical keys or a key pad. The ultrasonic input system 258 is a device that senses sounds via a microphone 288 of the electronic device 101 by using an input tool for generating ultrasonic signals and checks the data. The ultrasonic input system 258 senses signals in wireless mode. In an embodiment of the present disclosure, the electronic device 101 receives a user's inputs from an external system (e.g., a computer or server) via the communication module 220.

The display 260 (e.g., display 150) includes a panel 262, a hologram unit 264, or a projector 266. The panel 262 is implemented with a Liquid Crystal Display (LCD), Active Matrix Organic Light Emitting Diodes (AMOLEDs), or the like. The panel 262 is implemented in a flexible, transparent, or wearable form. The panel 262 forms a single module with the touch panel 252. The hologram unit 264 shows a three-dimensional image in the air using interference of light. The projector 266 displays images by projecting light on a screen. The screen is placed, for example, inside or outside the electronic device 101. In an embodiment of the present disclosure, the display module 260 further includes a control circuit for controlling the panel 262, the hologram unit 264, or the projector 266.

The interface 270 includes a high-definition multimedia interface (HDMI) 272, a universal serial bus (USB) 274, an optical interface 276, a D-subminiature (D-sub) 278, etc. The interface 270 also is included in the communication interface 160 shown in FIG. 1. The interface 270 also includes a mobile high-media card (MHL) interface, a secure digital (SD) card, a multi-media card (MMC) interface, an infrared data association (IrDA) standard interface, or the like.

The audio module 280 makes conversion between audios and electrical signals. At least part of the components in the audio module 280 is included in the input/output interface 140 shown in FIG. 1. The audio module 280 processes audios output from/input to, for example, a speaker 282, a receiver 284, earphones 286, a microphone 288, etc.

The camera module 291 takes still images or moving images. In an embodiment of the present disclosure, the camera module 291 includes one or more image sensors (e.g., on the front side and/or the back side), a lens, an image signal processor (ISP), a flash (e.g., an LED or a xenon lamp), or the like.

The power management module 295 manages electric power supplying to the electronic device 101. The power management module 295 includes a power management integrated circuit (PMIC), a charger integrated circuit (IC), a battery or fuel gauge, etc.

The PMIC is implemented in the form of IC chip or SoC. Charging electric power be performed in wired or wireless mode. The charger IC charges a battery, preventing input over-voltage or input over-current from inputting to the battery from a charger. In an embodiment of the present disclosure, the charger IC is implemented with a wired charging type and/or a wireless charging type. Examples of the wireless charging type of charger IC are a magnetic resonance type, a magnetic induction type, an electromagnetic type, etc. If the charger IC is implemented with a wireless charging type, it includes an additional circuit for wireless charging, e.g., a coil loops, a resonance circuit, a rectifier, etc.

The battery gauge measures the residual amount of battery 296, the level of voltage, the level of current, temperature during the charge. The battery 296 charges electric power and supplies it to the electronic device 101. The battery 296 includes a rechargeable battery or a solar battery.

The indicator 297 shows states of the electronic device 101 or of the parts (e.g., AP 210), e.g., a booting state, a message state, a recharging state, etc. The motor 298 converts an electrical signal into a mechanical vibration. Although it is not shown, the electronic device 101 includes a processor for supporting a mobile TV, e.g., a graphic processing unit (GPU). The mobile TV supporting processor processes media data that comply with standards of digital multimedia broadcasting (DMB), digital video broadcasting (DVB), media flow, etc.

Each of the elements/units of the electronic device according to the present disclosure be implemented with one or more components, and be called different names according to types of electronic devices. The electronic device according to the present disclosure includes at least one element described above. The electronic device is modified in such a way as to: remove part of the elements or include new elements. In addition, the electronic device according to the present disclosure also is modified in such a way that parts of the elements are integrated into one entity that performs their original functions.

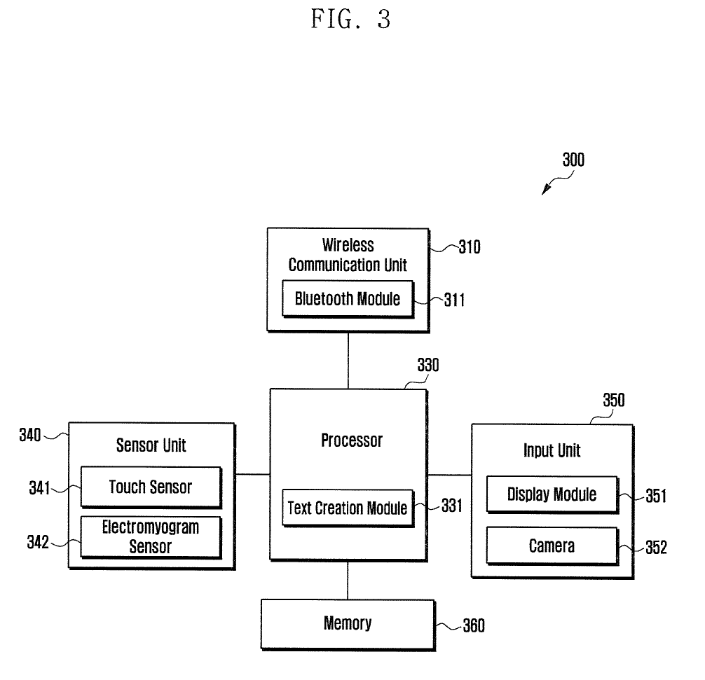

FIG. 3 is a block diagram illustrating an electronic device in accordance with various embodiments of the present disclosure.

Referring to FIG. 3, the electronic device 300 constitutes, for example, the whole or part of the electronic device 200 shown in FIG. 2. The electronic device 300 includes a wireless communication unit 310, a processor 330, a sensor unit 340, an input unit 350, and a memory 360.

The wireless communication unit 310 is the same as the communication module 220 shown in FIG. 2. The wireless communication unit 310 includes therein a Bluetooth module 311, which is the same as the BT module 225 shown in FIG. 2.

The processor 330 includes therein a text creation module 331 which creates text (i.e., one or more letters that form a written passage) through a key selection from the input unit 350 or the sensor unit 340. A mapping relation between a key and a letter is stored in the memory 360.

The sensor unit 340 is the same as the sensor module 240 shown in FIG. 2. The input unit 350 is the same as the input device 250 shown in FIG. 2. The input unit 350 includes a display module 351 and a camera 352. The camera 352 is the same as the camera module 291 shown in FIG. 2. The processor 330 determines an input by detecting a selection on the display module 351. The text creation module 331 recognizes, as a key selection, an image captured by the camera 352 and creates a text input based on a letter mapped with the recognized key selection.

The memory 360 is the same as the memory 230 shown in FIG. 2. The memory 360 stores therein a mapping relation between a selectable key and a creatable letter. The processor 330 retrieves a letter corresponding to a selected key input from the memory 360 and creates a text input from the retrieved letter. For example, the processor 330 recognizes selected specific keys, retrieve letters (e.g., ‘g’ and ‘o’) mapped with the recognized keys, and create a text input (e.g., ‘go’) from the retrieved letters.

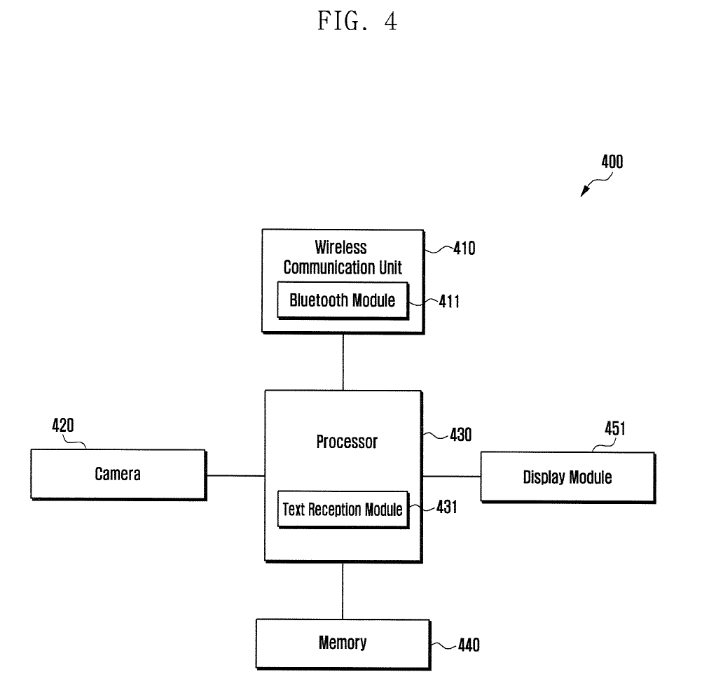

FIG. 4 is a block diagram illustrating an external electronic device in accordance with various embodiments of the present disclosure.

Referring to FIG. 4, the external electronic device 400 includes a wireless communication unit 410, a camera 420, a processor 430, a memory 440, and a display module 451.

The wireless communication unit 410 is the same as the communication module 220 shown in FIG. 2. The wireless communication unit 410 includes therein a Bluetooth module 411, which is the same as the BT module 225 shown in FIG. 2. The camera 420 is the same as the camera module 291 shown in FIG. 2. The processor 430 includes therein a text reception module 431. The text reception module 431 controls the Bluetooth module 411 to receive the created text input from the electronic device 300. Also, the text reception module 431 controls the display module 451 to display the received text input. The memory 440 is the same as the memory 230 shown in FIG. 2. The display module 451 is the same as the display module 260 shown in FIG. 2.

According to various embodiments of this disclosure, the text creation module 331 of FIG. 3 is contained in the processor 430 of FIG. 4. Namely, without the text creation module 331, the electronic device 300 shown in FIG. 3 recognizes a key input from the sensor unit 340 or the camera 352 and, by controlling the Bluetooth module, transmits the recognized key input to the external electronic device 400. Then the processor 430 of the external electronic device 400 receives the key input from the electronic device 300 and, by controlling the text creation module 331 equipped therein, creates a text input based on the received key input. Further, the processor 430 of the external electronic device 400 controls the display module 451 to display the created text input.

According to various embodiments of this disclosure, an electronic device comprises a sensor unit including a touch sensor configured to detect a key input based on a touch, and a keypad including a first key group and a second key group. The first key group has a first plurality of keys and a first shift key, and the second key group has a second plurality of keys and a second shift key. The first plurality of keys performs a first input or a second input by detecting the key input from the sensor unit, and the first shift key performs the second input by detecting the key input from the sensor unit. The second plurality of keys performs a third input or a fourth input by detecting the key input from the sensor unit, and the second shift key performs the fourth input by detecting the key input from the sensor unit. The electronic device further comprises a wireless communication unit configured to communicate with an external electronic device, and a processor configured to recognize a specific key selected from the keypad, to activate the recognized key, to create a letter corresponding to the activated key, and to transmit the created letter to the external electronic device for displaying the created letter through the wireless communication unit.

According to various embodiments of this disclosure, an electronic device comprises an input unit including a camera configured to capture an image, a wireless communication unit configured to communicate with an external electronic device, and a processor configured to receive the captured image from the camera, to create a letter by recognizing the letter from the received image, and to transmit the created letter to the external electronic device for displaying the created letter through the wireless communication unit.

According to various embodiments of this disclosure, an electronic device comprises a sensor unit including an electromyogram sensor configured to detect a movement of user's muscles, a wireless communication unit configured to communicate with an external electronic device, and a processor configured to receive the detected muscle movement from the electromyogram sensor, to create a letter corresponding to the received muscle movement, and to transmit the created letter to the external electronic device for displaying the created letter through the wireless communication unit.

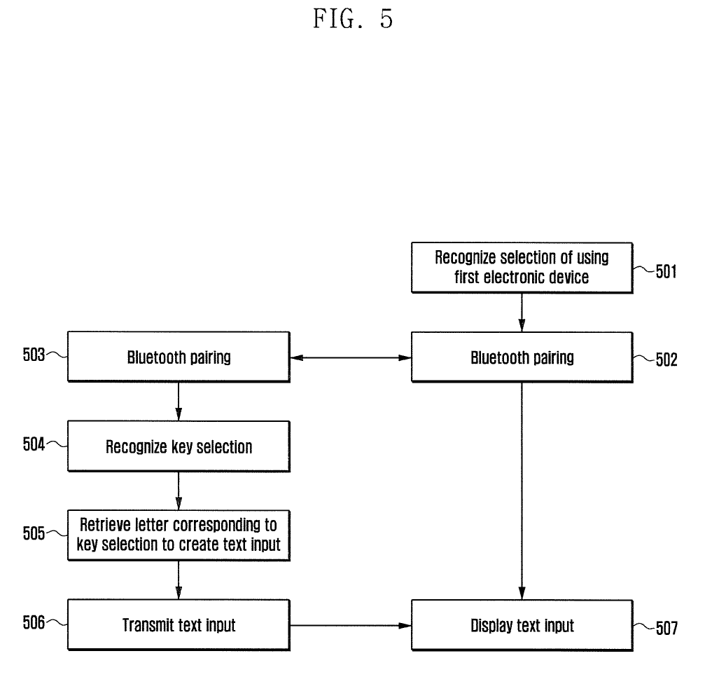

FIG. 5 is a flow diagram illustrating a text input and display process based on a communication between electronic devices in accordance with various embodiments of the present disclosure.

Referring to FIG. 5, the processor 430 of the external electronic device 400 recognizes a user's selection of using the electronic device 300 at operation 501. Then the processor 430 of the external electronic device 400 is set to receive a key recognition from the electronic device 300. At operations 502 and 503, the electronic device 300 and the external electronic device 400 perform a Bluetooth pairing for connecting them with each other by means of Bluetooth. In some embodiments, the first and second electronic devices are connected with each other based on any other short range communication technique.

At operation 504, the text creation module 331 of the electronic device 300 recognizes a user's key selection. This key selection or key input depends on types of electronic device. If the electronic device 300 is a glasses type, a watch type, or a band type, the text creation module 331 of the electronic device 300 recognizes a key selection by processing an image captured through the camera 352. If the electronic device 300 has the touch sensor 341, the text creation module 331 of the electronic device 300 recognizes a key selection from the touch sensor 341. If the electronic device 300 has the electromyogram sensor 342, the text creation module 331 of the electronic device 300 recognizes a key selection from the electromyogram sensor 342 through variations in a movement of user's muscles.

At operation 505, the text creation module 331 of the electronic device 300 creates a text input based on the key selection recognized at operation 504. This text input refer to one or more letters each of which is a component of an alphabet or a symbol. In case of Korean alphabet, a text input includes an initial consonant, a vowel, and a final consonant. When the text creation module 331 of the electronic device 300 recognizes a user's key selection, the text creation module 331 retrieves letter(s) corresponding to such a key selection from the memory 360 and then creates a text input formed of the retrieved letter(s).

At operation 506, the text creation module 331 of the electronic device 300 transmits the created text input to the external electronic device 400 through the Bluetooth module 311 of the wireless communication module 310. In some embodiments, the first and second electronic devices communicate with each other based on any other short range communication technique. At operation 507, the external electronic device 400 displays the text input received from the electronic device 300 on the display module 451.

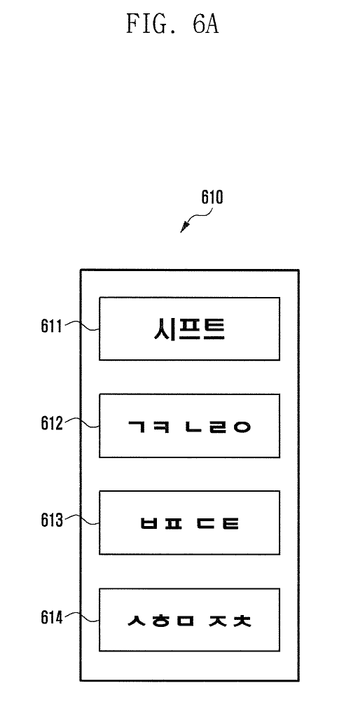

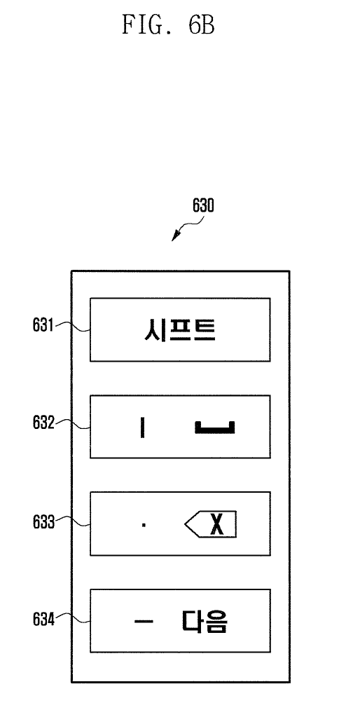

FIGS. 6A and 6B show examples of key arrangement for a text input in accordance with embodiments of the present disclosure.

Referring to FIGS. 6A and 6B, keys of the electronic device 300 is arranged to correspond to parts of a user's body, e.g., eight fingers other than left and right thumbs. FIG. 6A shows a key arrangement corresponding to four fingers of user's left hand, and FIG. 6B shows a key arrangement corresponding to four fingers of user's right hand. Various key arrangements and body part correspondences are possible and the figures of the present disclosure are for example only and should not be construed as a limitation of this disclosure. The key arrangements illustrated in the figures are changed according to user's setting. The key arrangement is displayed or not on the display module 451 of the external electronic device 400 or the electronic device 300. Keys shown in FIGS. 6A and 6B is arranged to correspond to the touch sensor 341 or the electromyogram sensor 342. The following description will be focused on, for example, key recognition based on a user's finger touch.

Referring to FIG. 6A, a left key arrangement 610 includes a first shift key 611, a ‘ [symbol] ’ key 612, a ‘ [symbol] ’ key 613, and a ‘ [symbol] ’ key 614. The text creation module 331 activates the first shift key 611 when a touch of the left hand's forefinger is detected from the touch sensor 341. In the ‘ [symbol] ’ key 612, letters ‘ [symbol] ’ is activated when a touch of the left hand's middle finger is detected from the touch sensor 341. Specifically, the text creation module 331 activates a letter ‘ [symbol] ’ in response to a single touch of the left hand's middle finger and activate a letter ‘ [symbol] ’ in response to a double touch of the left hand's middle finger. Additionally, letters ‘ [symbol] ’ is activated when a touch of the left hand's middle finger is detected together with a touch of the left hand's forefinger (acting as a shift function) from the touch sensor 341. Specifically, letters ‘ [symbol] ’and ‘ [symbol] ’ and ‘ [symbol] ’ is activated respectively in response to a single touch, a double touch, and a triple touch.

Similarly, in the ‘ [symbol] ’ key 613, letters ‘ [symbol] ’ is activated when a touch of the left hand's ring finger is detected from the touch sensor 341. Specifically, the text creation module 331 activates a letter ‘ [symbol] ’in response to a single touch of the left hand's ring finger and activate a letter ‘ [symbol] ’ in response to a double touch of the left hand's ring finger. Additionally, letters ‘ [symbol] ’ is activated when a touch of the left hand's ring finger is detected together with a touch of the left hand's forefinger from the touch sensor 341. Specifically, letters ‘ [symbol] ’ and ‘ [symbol] ’ is activated respectively in response to a single touch and a double touch. Similarly, in the ‘ [symbol] ’ [symbol] key 614, key 614, letters ‘ [symbol] ’ is activated when a touch of the left hand's little finger is detected from the touch sensor 341. Specifically, the text creation module 331 activates a letter ‘ [symbol] ’ in response to a single touch of the left hand's little finger, activate a letter ‘ [symbol] ’ in response to a double touch of the left hand's little finger, and activate a letter ‘ [symbol] ’ in response to a triple touch of the left hand's little finger. Additionally, letters ‘ [symbol] ’ is activated when a touch of the left hand's little finger is detected together with a touch of the left hand's forefinger from the touch sensor 341. Specifically, letters ‘ [symbol] ’ and ‘ [symbol] ’ is activated respectively in response to a single touch and a double touch.

Further, the left key arrangement 610 has a double consonant. Namely, the text creation module 331 activates a double consonant by recognizing a triple or more touch from the touch sensor 341. Specifically, a letter ‘ [symbol] ’ is activated in response to a triple touch of the left hand's middle finger. Similarly, a letter ‘ [symbol] ’is activated in response to a triple touch of the left hand's ring finger. Similarly, a letter ‘ [symbol] ’is activated in response to a quadruple touch of the left hand's little finger. Additionally, a letter ‘ [symbol] ’is activated when a triple touch of the left hand's ring finger is detected together with a touch of the left hand's forefinger. Similarly, a letter ‘ [symbol] ’; is activated when a triple touch of the left hand's little finger is detected together with a touch of the left hand's forefinger.

Referring to FIG. 6B, a right key arrangement 630 corresponds to a second key group formed of a second shift key 631, a ‘ [symbol] a’n key 632, a ‘ [symbol] ’ key 633, and a ‘ [symbol] ’key 634. The second shift key 631 acts the same function as the first shift key 611 discussed above. If either of the first and second shift keys 611 and 631 is detected, a related key activation is performed. For example, as discussed above, a letter ‘ [symbol] ’ in the left key arrangement 610 is activated when a double touch of the left hand's middle finger is detected together with a touch of the left hand's forefinger (corresponding to the first shift key 611) from the touch sensor 341. Similarly, a letter ‘ [symbol] ’ is also activated when a double touch of the left hand's middle finger is detected together with a touch of the right hand's forefinger (corresponding to the second shift key 631) from the touch sensor 341.

In the ‘I [symbol] ’ key 632, a letter ‘I’ is activated when the text creation module 331 recognizes a touch of the right hand's middle finger from the touch sensor 341. Also, a letter ‘ [symbol] ’ is activated when the text creation module 331 recognizes a touch of the right hand's middle finger together with a touch of the left or right hand's forefinger from the touch sensor 341. Similarly, in the ‘ [symbol] ’ key 633, a letter ‘.’ is activated in response to a touch of the right hand's ring finger, and a letter ‘ [symbol] ’ is activated in response to a touch of the right hand's ring finger together with a touch of the left or right hand's forefinger. Similarly, in the key ‘ [symbol] ’ 634, a letter ‘-’ is activated in response to a touch of the right hand's little finger, and a letter ‘ [symbol] ’ is activated in response to a touch of the right hand's little finger together with a touch of the left or right hand's forefinger.

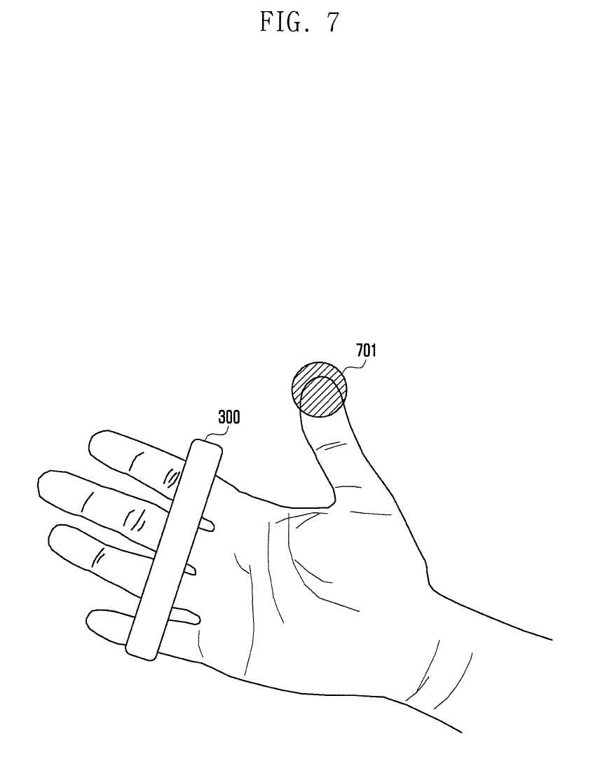

FIG. 7 shows an operation example of the electronic device in accordance with embodiments of the present disclosure.

Referring to FIG. 7, the electronic device 300 is attached to a user's hand, e.g., the right hand as shown. Alternatively, the electronic device 300 is attached to any other part of a user's body. Further, what is attached to the user's hand is the electronic device 300 having the sensor unit 340 therein or only the sensor unit 340 of the electronic device 300. The sensor unit 340 attached to or located at the user's left or right hand operates as the left or right key arrangement 610 or 630 discussed above. In some embodiments, two or more first electronic devices 300 is used together to perform individual functions. One of them is attached to the left hand, and the other is attached to the right hand

In the electronic device 300 as shown in FIG. 7, the text creation module 331 recognizes a key input when the sensor unit 340 detects a user's touch. A user performs a key input by touching, with thumb 701, the sensor unit 340 corresponding to each finger. Then the text creation module 331 of the electronic device 300 recognizes a user's key input and creates a text input based on the detected key input. Also, the text creation module 331 controls the Bluetooth module 311 of the wireless communication module 310 to transmit the created text input to the external electronic device 400. Then the text reception module 431 of the external electronic device 400 receives the text input from the electronic device 300 through the Bluetooth module 411 of the wireless communication unit 410. Also, the external electronic device 400 controls the display module 451 to display the received text input.

The text creation module 331 of the electronic device 300 recognizes that a user touches the touch sensor on each finger with his or her thumb 701. For example, in order to enter ‘ [symbol] ’ of the second key group, a user simultaneously touches the touch sensor 341, corresponding to the forefinger and the ring finger, with the thumb 701. Then the text creation module 331 of the electronic device 300 recognizes input letter(s) by retrieving data corresponding to the touch input from the memory 360.

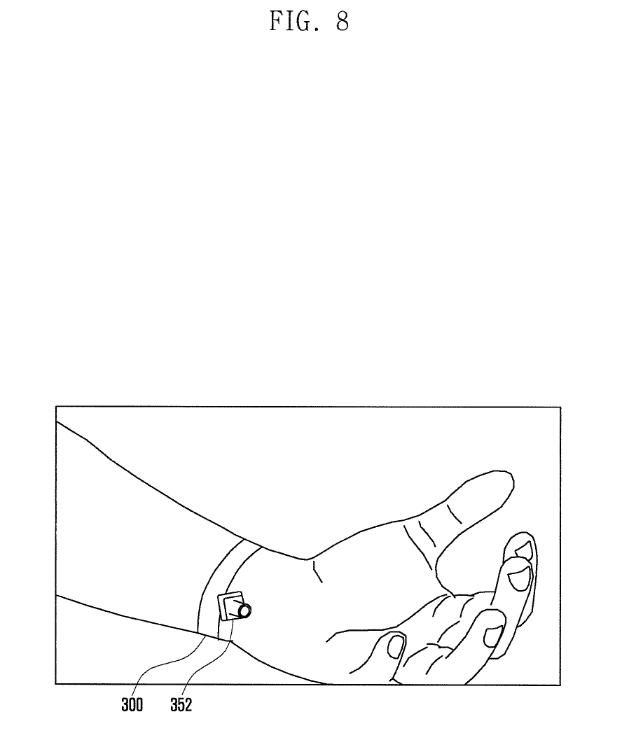

FIG. 8 shows another operation example of the electronic device in accordance with embodiments of the present disclosure.

Referring to FIG. 8, contrary to FIG. 7, the electronic device 300 is realized in the form of band or watch. The electronic device 300is wound around a user's wrist or arm or any other part of a user's body. The electronic device 300 recognizes a text input by analyzing an image captured by the camera 352 rather than by using the sensor unit 340 as shown in FIG. 7. The electronic device 300 is attached to a user's left wrist as shown. Therefore, the camera 352 of the electronic device 300 analyzes a captured image of the left hand fingers and recognizes a text input with regard to the left key arrangement 610. In some embodiments, two or more first electronic devices 300 is used together to perform individual functions. One of them is attached to the left arm, and the other is attached to the right arm.

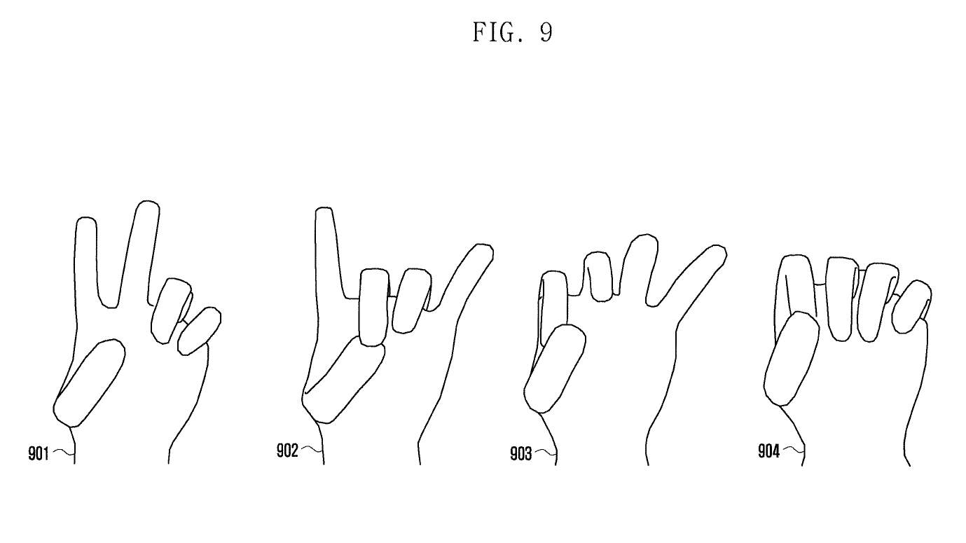

FIG. 9 shows a text input example of the electronic device in accordance with embodiments of the present disclosure.

FIG. 9 shows a user's finger image captured by the electronic device 300 having the camera 352 as shown in FIG. 8. The memory 360 of the electronic device 300 stores therein finger images corresponding to letters. The camera 352 of the electronic device 300 transmits an image or video recording a user's finger motion or gesture to the text creation module 331. Then the text creation module 331 determines whether the received image or video contains the same finger pattern as that stored in the memory 360. If any captured finger pattern is identical to a stored finger pattern, the text creation module 331 transmits a letter mapped with the finger pattern to the external electronic device 400 through the Bluetooth module 311.

For example, finger pattern images 901, 902, 903 and 904 represents respective letters. A mapping relation between such images and corresponding letters are stored in the memory.

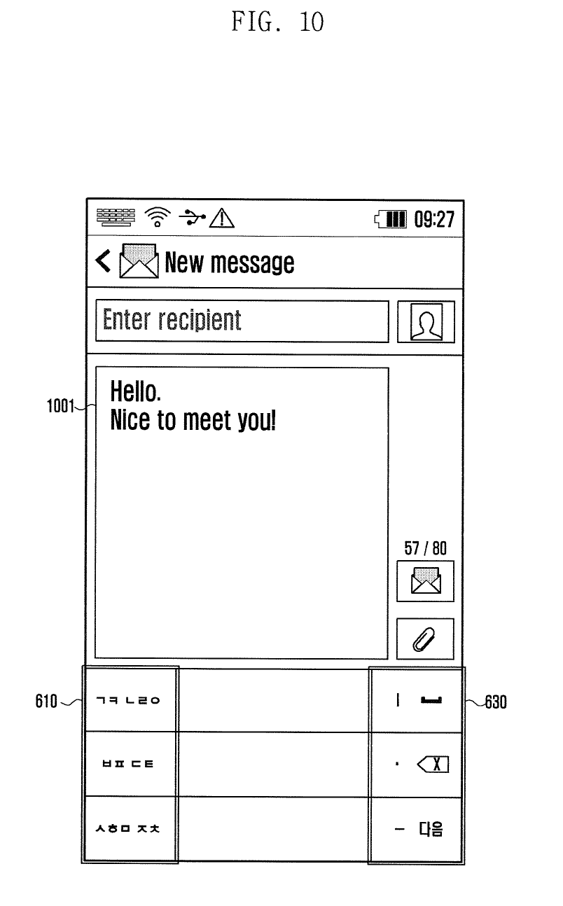

FIG. 10 shows a text display example of the external electronic device in accordance with embodiments of the present disclosure.

Referring to FIG. 10, the external electronic device 400 displays a text input received from the electronic device 300. Namely, the external electronic device 400 receives a text input through the Bluetooth module 411 and then output the received text input to the display module 451. Also, the text reception module 431 of the external electronic device 400 controls the display module 451 to display the left key arrangement 610 and the right key arrangement 630 in connection with the electronic device 300.

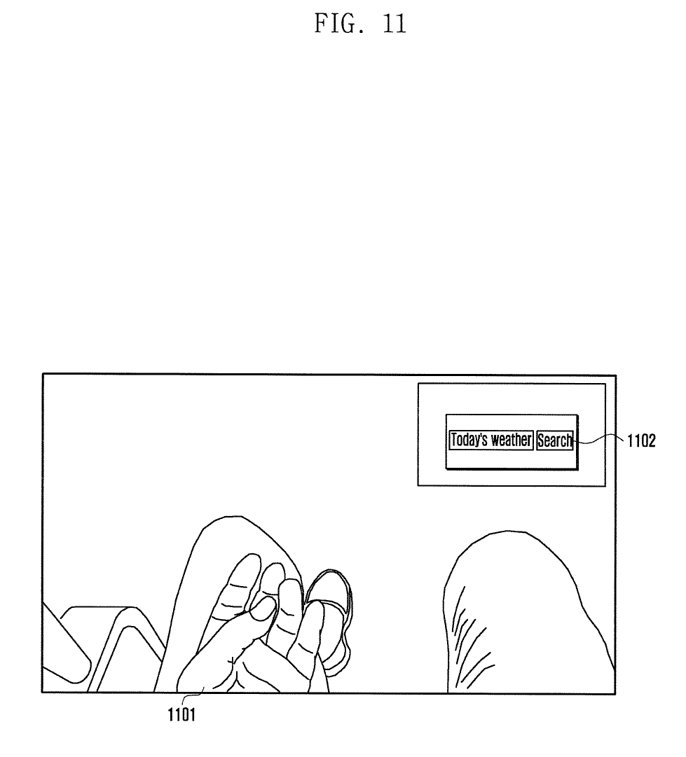

FIG. 11 shows a text input example in accordance with embodiments of the present disclosure.

Referring to FIG. 11, when a user desires to perform a text input during use of the external electronic device 400, he or she uses the electronic device 300. The electronic device 300 recognizes a user's touch or gesture through the touch sensor 341 or the electromyogram sensor 342, retrieve letter(s) corresponding to the detected touch or gesture from the memory 360, and transmit the retrieved letter(s) to the external electronic device 400 through the Bluetooth module 311. Then the text reception module 431 of the external electronic device 400 receives such letter(s) from the electronic device 300 through the Bluetooth module 411 and display the received letter(s) on the display module 451. For example, as shown, the external electronic device 400 displays in a search box a text input ‘today's weather’ which is received from the electronic device 300. Next, the text creation module 331 of the electronic device 300 recognizes a user's selection of ‘ [symbol] ’ key (which means the enter key) and transmit this to the external electronic device 400. Then, in response to this key selection, the external electronic device 400 activates a search button 1102 to start a search process.

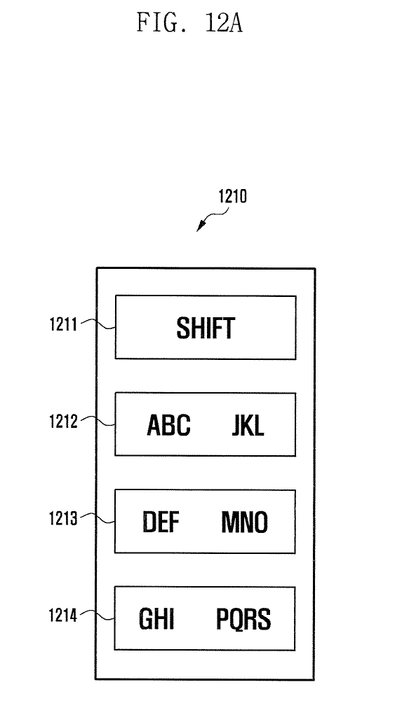

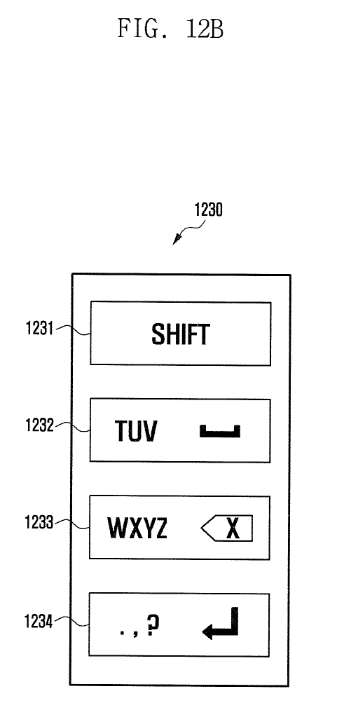

FIGS. 12A and 12B show examples of key arrangement for a text input in accordance with embodiments of the present disclosure.

The key arrangements shown in FIGS. 12A and 12B are for example only and not to be construed as a limitation of this disclosure. These key arrangements are varied according to user's setting. Referring to FIG. 12A, a left key arrangement 1210 corresponds to a first key group formed of a ‘SHIFT’ key 1211 corresponding to the first shift key discussed above, a ‘ABC JKL’ key 1212, a ‘DEF MNO’ key 1213, and a ‘GHI PQRS’ key 1214. The text creation module 331 activates the first shift key 1211 when a touch of the left hand's forefinger is detected from the touch sensor 341. In the ‘ABC JKL’ key 1212, letters ‘ABC’ are activated when a touch of the left hand's middle finger is detected from the touch sensor 341. Specifically, the text creation module 331 activates a letter ‘A’ in response to a single touch of the left hand's middle finger, activate a letter ‘B’ in response to a double touch of the left hand's middle finger, and activate a letter ‘C’ in response to a triple touch of the left hand's middle finger. Additionally, letters ‘JKL’ are activated when a touch of the left hand's middle finger is detected together with a touch of the left hand's forefinger (acting as a shift function) from the touch sensor 341. Specifically, letters ‘J’, ‘K’ and ‘L’ are activated respectively in response to a single touch, a double touch, and a triple touch.

Similarly, in the ‘DEF MNO’ key 1213, letters ‘DEF’ are activated when a touch of the left hand's ring finger is detected from the touch sensor 341. Specifically, the text creation module 331 activates a letter ‘D’ in response to a single touch of the left hand's ring finger, activate a letter ‘E’ in response to a double touch of the left hand's ring finger, and activate a letter ‘F’ in response to a triple touch of the left hand's ring finger. Additionally, letters ‘MNO’ are activated when a touch of the left hand's ring finger is detected together with a touch of the left hand's forefinger from the touch sensor 341. Specifically, letters ‘M’, ‘N’ and ‘O’ are activated respectively in response to a single touch, a double touch, and a triple touch. Similarly, in the ‘GHI PQRS’ key 1214, letters ‘GHI’ are activated when a touch of the left hand's little finger is detected from the touch sensor 341. Specifically, the text creation module 331 activates a letter ‘G’ in response to a single touch of the left hand's little finger, activate a letter ‘H’ in response to a double touch of the left hand's little finger, and activate a letter ‘I’ in response to a triple touch of the left hand's little finger. Additionally, letters ‘PQRS’ are activated when a touch of the left hand's little finger is detected together with a touch of the left hand's forefinger from the touch sensor 341. Specifically, letters ‘P’, ‘Q’, ‘R’ and ‘S’ are activated respectively in response to a single touch, a double touch, a triple touch, and a quadruple touch.

Referring to FIG. 12B, a right key arrangement 1230 corresponds to a second key group formed of a ‘SHIFT’ key 1231 corresponding to the second shift key discussed above, a ‘TUV [symbol] ’ key 1232, a ‘WXYZ [symbol] ’ key 1233, and a ‘.,? [symbol] ’ key 1234. The second shift key 1231 acts the same function as the first shift key 1211 discussed above. If either of the first and second shift keys 1211 and 1231 is recognized, a related key activation is performed. For example, as discussed above, a letter ‘J’ in the left key arrangement 1210 is activated when a double touch of the left hand's middle finger is detected together with a touch of the left hand's forefinger (corresponding to the first shift key 1211) from the touch sensor 341. Similarly, a letter ‘J’ is also activated when a double touch of the left hand's middle finger is detected together with a touch of the right hand's forefinger (corresponding to the second shift key 1231) from the touch sensor 341.

In the ‘TUV [symbol] ’ key 1232, letters ‘TUV’ are activated when the text creation module 331 recognizes a touch of the right hand's middle finger from the touch sensor 341. Specifically, letters ‘T’, ‘U’ and ‘V’ are activated respectively in response to a single touch, a double touch, and a triple touch. Also, a letter ‘ [symbol] ’ are activated when the text creation module 331 recognizes a touch of the right hand's middle finger together with a touch of the left or right hand's forefinger from the touch sensor 341. Similarly, in the ‘WXYZ [symbol] ’ key 1233, letters ‘WXYZ’ are activated in response to a touch of the right hand's ring finger. Specifically, letters ‘W’, ‘X’, ‘Y’ and ‘Z’ are activated respectively in response to a single touch, a double touch, a triple touch, and a quadruple touch. Also, a letter ‘ [symbol] ’ is activated in response to a touch of the right hand's ring finger together with a touch of the left or right hand's forefinger. Similarly, in the ‘.,? [symbol] ’ key 1234, letters ‘.,?’ are activated in response to a touch of the right hand's little finger. Specifically, letters ‘.’,‘,’ and ‘?’ are activated respectively in response to a single touch, a double touch, and a triple touch. Also, a letter ‘ [symbol] ’ are activated in response to a touch of the right hand's little finger together with a touch of the left or right hand's forefinger.

According to various embodiments of this disclosure, the text input method of the electronic device includes recognizing a selected key, activating the recognized key, creating a letter corresponding to the activated key, and transmitting the created letter to an external electronic device for displaying the created letter.

As fully discussed hereinbefore, the electronic device and method for a text input according to various embodiments of this disclosure obviates any inconvenience caused by entering text in a wearable device.

The term “module” according to the embodiments of the disclosure, means, but is not limited to, a unit of one of software, hardware, and firmware or any combination thereof. The term “module” is used interchangeably with the terms “unit,” “logic,” “logical block,” “component,” or “circuit.” The term “module” denotes a smallest unit of component or a part thereof. The term “module” is the smallest unit of performing at least one function or a part thereof A module is implemented mechanically or electronically. For example, a module includes at least one of Application-Specific Integrated Circuit (ASIC) chip, Field-Programmable Gate Arrays (FPGAs), and Programmable-Logic Device known or to be developed for certain operations.

According to various embodiments of the present disclosure, the devices (e.g. modules or their functions) or methods is implemented by computer program instructions stored in a computer-readable storage medium. In the case that the instructions are executed by at least one processor (e.g. processor 120), the at least one processor executes the functions corresponding to the instructions. The computer-readable storage medium is the memory 130. At least a part of the programing module is implemented (e.g. executed) by the processor 120. At least a part of the programing module includes modules, programs, routines, sets of instructions, and processes for executing the at least one function.

The computer-readable storage medium includes magnetic media such as a floppy disk and a magnetic tape, optical media including a Compact Disc (CD) ROM and a Digital Video Disc (DVD) ROM, a magneto-optical media such as a floptical disk, and the hardware device designed for storing and executing program commands such as ROM, RAM, and flash memory. The programs commands include the language code executable by computers using the interpreter as well as the machine language codes created by a compiler. The aforementioned hardware device is implemented with one or more software modules for executing the operations of the various exemplary embodiments of the present disclosure.

The module or programming module of the present disclosure includes at least one of the aforementioned components with omission of some components or addition of other components. The operations of the modules, programming modules, or other components is executed in series, in parallel, recursively, or heuristically. Also, some operations may be executed in different order, omitted, or extended with other operations.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. An electronic device comprising:
a sensor unit including a touch sensor configured to detect a key input based on a touch;
a keypad including a first key group and a second key group, the first key group having a first plurality of keys and a first shift key, the second key group having a second plurality of keys and a second shift key, the first plurality of keys performing a first input or a second input by detecting the key input from the sensor unit, the first shift key performing the second input by detecting the key input from the sensor unit, the second plurality of keys performing a third input or a fourth input by detecting the key input from the sensor unit, and the second shift key performing the fourth input by detecting the key input from the sensor unit;
a wireless communication unit configured to communicate with an external electronic device; and
a processor configured to recognize a specific key selected from the keypad, to activate the recognized key, to create a letter corresponding to the activated key, and to transmit the created letter to the external electronic device for displaying the created letter through the wireless communication unit.

2. The electronic device of claim 1, wherein the first plurality of keys in the first key group is configured to perform the first input ‘ [symbol] ’, ‘ [symbol] ’ ‘, [symbol] ’ or the second input ‘ [symbol] ’,‘ [symbol] ’or ‘ [symbol] ’ key and to allow a change in key arrangement.

3. The electronic device of claim 1, wherein the second plurality of keys in the second key group is configured to perform the third input ‘|’, ‘.’or ‘-’or the fourth input a ‘ [symbol] ’, ‘ [symbol] ’or ‘ [symbol] ’and to allow a change in key arrangement.

4. The electronic device of claim 1, wherein the first plurality of keys in the first key group is configured to perform the first input ‘ABC’, ‘DEF’ or ‘GHI’ or the second input ‘JXL’, ‘MNO’ or ‘PQRS’ key and to allow a change in key arrangement.

5. The electronic device of claim 1, wherein the second plurality of keys in the second key group is configured to perform the third input ‘TUV’, ‘WXYZ’ or ‘.,?’ or the fourth input a ‘ [symbol] ’,‘ [symbol] ’or ‘ [symbol] ’and to allow a change in key arrangement.

6. The electronic device of claim 1, wherein each of the first and second shift keys corresponds to a SHIFT key for performing the second input in the first key group or performing the fourth input in the second key group.

7. The electronic device of claim 1, wherein the processor is further configured to activate the specific key recognized through a touch sensor, an electromyogram sensor, or an image captured by a camera.

8. The electronic device of claim 1, wherein the processor is further configured to create letters corresponding to the keys in the first and second key groups.

9. The electronic device of claim 8, wherein the processor is further configured to create the letters selected by recognizing continuous key inputs on the keys in the first and second key groups.

10. The electronic device of claim 9, wherein the processor is further configured to create the letters including a double consonant by recognizing continuous key inputs on the keys in the first key group.

11. The electronic device of claim 1, wherein the wireless communication unit includes a Bluetooth module, and the processor is further configured to sequentially transmit the created letters to the external electronic device through the Bluetooth module.

12. An electronic device comprising:
an input unit including a camera configured to capture an image;
a wireless communication unit configured to communicate with an external electronic device; and
a processor configured to receive the captured image from the camera, to create a letter by recognizing the letter from the received image, and to transmit the created letter to the external electronic device for displaying the created letter through the wireless communication unit.

13. An electronic device comprising:
a sensor unit including an electromyogram sensor configured to detect a movement of user's muscles;
a wireless communication unit configured to communicate with an external electronic device; and
a processor configured to receive the detected muscle movement from the electromyogram sensor, to create a letter corresponding to the received muscle movement, and to transmit the created letter to the external electronic device for displaying the created letter through the wireless communication unit.

14. A text input method of an electronic device, the method comprising:
recognizing a selected key;
activating the recognized key;
creating a letter corresponding to the activated key; and
transmitting the created letter to an external electronic device for displaying the created letter.

15. The method of claim 14, wherein the activating of the recognized key includes activating the selected key recognized through a touch sensor, an electromyogram sensor, or an image captured by a camera.

16. The method of claim 14, wherein the creating of the letter includes creating letters corresponding to keys in first and second key groups.

17. The method of claim 16, wherein the creating of the letter includes creating the letters selected by recognizing continuous key inputs on the keys in the first and second key groups.

18. The method of claim 17, wherein the creating of the letter includes creating the letters including a double consonant by recognizing continuous key inputs on the keys in the first key group.

19. The method of claim 14, wherein the transmitting of the created letter includes sequentially transmitting the created letters to the external electronic device through a wireless communication unit including a Bluetooth module.
